(19) United States
(12) Patent Application Publication
(10) Pub. No.: US 2021/0247226 A1
(43) Pub. Date: Aug. 12, 2021

(54) Filling Level Indicator

(71) Applicant: Continental Automotive GmbH, Hannover (DE)

(72) Inventors: Hans Guenter BENNER, Kriftel (DE); Bernd Pauer, Eppstein (DE)

(21) Appl. No.: 16/319,044

(22) PCT Filed: Jul. 14, 2017
(86) PCT No.: PCT/EP2017/067865

§ 371 Date: Jan. 18, 2019

(30) Foreign Application Priority Data
Jul. 22, 2016 (DE) 102016213506.6

(51) Int. Cl. G01F 23/60

(52) U.S. Cl. CPC G01F 23/60

(57) ABSTRACT

A filling level indicator for determining a filling level in a tank, having a resistor network, a contact element, and a magnetic element. The contact element is spaced apart from the resistor network, and the magnetic element is movable relative to the resistor network and the contact element. The contact element has a contact region deflectable by the magnetic element. An electrically conductive connection between the contact region and the resistor network can be established by the deflection of the contact region. A spacer element is disposed between the contact element and the resistor network. A predefinable spacing is generated by the spacer element, which is formed from a fuel-resistant material.

### CROSS REFERENCE TO RELATED APPLICATIONS

This is a U.S. national stage of application No. PCT/EP2017/067865, filed on Jul. 14, 2017. Priority is claimed on German Application No. DE102016213506.6, filed Jul. 22, 2016, the content of which is incorporated here by reference.

### BACKGROUND OF THE INVENTION

### 1. Field of the Invention

The invention relates to a filling level indicator for determining a filling level in a tank, having a resistor network, a contact element, and a magnetic element, wherein the contact element is disposed so as to be spaced apart from the resistor network, and the magnetic element is movable relative to the resistor network and the contact element, wherein the contact element has a contact region that is deflectable by the magnetic element, wherein an electrically conductive connection between the contact region and the resistor network is capable of being established by the deflection of the contact region.

### 2. Description of the Prior Art

Filling level indicators for determining the filling level in a fuel tank have a resistor network, which generates a signal as a function of the actual filling level. The signal corresponds to a filling level in the fuel tank. For this purpose, a float is generally provided that floats on the surface of the fuel in the fuel tank and acts on the resistor network by a linkage mechanism and a sliding contact. The movement of the float owing to a rising or falling filling level is transmitted via the linkage mechanism to the sliding contact, which is moved past the resistor network as a result of the movement. Here, a varying signal is generated as a function of the position of the sliding contact. By standardizing the signal and by configuring the resistor network in a specific way, it is possible to infer the filling level in the fuel tank directly from the signal generated at the resistor network. Such filling level indicators are known in a wide variety of forms in the prior art.

Moreover, filling level indicators are known which, instead of a sliding contact, have a contact element that has a multiplicity of finger-like portions which can be deflected by a magnetic force in such a way that electrical contact is generated between the finger-like portion and a resistor network. A signal is generated as a result of the generation of the electrical contact. By the generated signal, it is possible to infer the filling level in the fuel tank directly as a function of the configuration of the resistor network and of the contact element. Such a filling level indicator is known, for example, from DE 197 01 246 A1. It is in particular disadvantageous in this concept that the contact element is spaced apart from the ceramic disk on which the resistor network is disposed by a PE film. This is disadvantageous since the PE film is sensitive to the corrosive influences of the fuel. This leads to such a filling level indicator having to be sealed with great complexity in a fluid-tight manner in relation to the fuel surrounding said filling level indicator.

A disadvantage of the devices having sliding contacts known in the prior art is in particular that the sliding contact on the resistor network constitutes a mechanical contacting element, which is subject to inevitable wear. Furthermore, the sliding contact and the resistor network are in this case arranged entirely in the fuel within the fuel tank, which can result in damaging effects caused by the fuel.

### SUMMARY OF THE INVENTION

An object of one aspect of the present invention is a filling level indicator that has a mechanically more durable contact element and which at the same time permits wear-free generation of a signal, as accurately as possible, which is dependent on the filling level in the fuel tank.

One exemplary embodiment of the invention relates to a filling level indicator for determining a filling level in a tank, having a resistor network, a contact element, and a magnetic element. The contact element is disposed so as to be spaced apart from the resistor network and the magnetic element is movable relative to the resistor network and the contact element. The contact element has a contact region which is deflectable by the magnetic element. An electrically conductive connection between the contact region and the resistor network is capable of being established by the deflection of the contact region. A spacer element is disposed between the contact element and the resistor network, and a predefinable spacing is generated by the spacer element between the contact element, and in particular between the contact region of the contact element, and the resistor network. The spacer element is formed from a fuel-resistant material.

The spacer element is required for generating a defined spacing between the resistor network and the contact element, or the contact region of the contact element, respectively. Since the entire filling level indicator is preferably disposed directly in the fuel tank and washed by fuel, either a particularly high complexity has to be undertaken in order for the housing of the filling level indicator to be embodied in a fluid-tight manner, or a suitable choice of material has to be made in order for the filling level indicator to be rendered insensitive to the corrosive properties of the fuel, so as to ensure the functional capability. A fuel-resistant material for the spacer element is therefore particularly advantageous.

It is particularly advantageous if the spacer element is formed from a corrosion-resistant metallic material. A metallic material is particularly advantageous since a multiplicity of materials that are resistant to the corrosive properties of fuel are known. Moreover, the production and processing of the spacer element is possible in a simple and diverse manner.

It is also advantageous if the contact element is formed from a plastics material. This is advantageous in order to enable a particularly cost-effective production of the contact element. It is particularly advantageous in a contact element from plastics material that said contact element is producible in diverse shapes and has a sufficiently high flexibility. A fuel-resistant material is particularly preferably used for the contact element.

One preferred embodiment is characterized in that the contact element has an electrically conductive coating on that side that faces the resistor network. An electrically conductive coating is required as long as the contact element is made from a material that is not inherently electrically conductive. Only in this way can an electric circuit be closed by physical contact between the contact element and the resistor network. In one advantageous design embodiment the contact element that is formed from a fundamentally electrically non-conductive material can also have conductive structures, which are applied to the surface, in particular to that surface that faces the resistor network. Such electrically conductive structures can also be integrated in the contact element and be routed to the surface of the contact element only in the region of potential contact between the contact element and the resistor network.

The complete coating of the contact element with an electrically conductive coating can also be provided. Said coating in this instance is preferably configured so as to be thin in such a manner that the flexibility of the contact element is not compromised.

It is also preferable if the spacer element is temperature-insensitive and dimensionally stable in a temperature range from −40 degrees to +125 degrees celcius. The dimensional stability across said wide temperature range is advantageous since, in particular, such temperatures within the fuel tank have to be taken into account in the normal operation.

It is moreover advantageous if the resistor network and the spacer element are disposed on a ceramic carrier substrate, wherein the spacer element is screw-fitted, adhesively bonded, or interference-fitted to the carrier substrate. This is particularly advantageous for a durable and dimensionally stable connection to be generated between the spacer element and the resistor network, or the carrier substrate of the resistor network, respectively.

It is furthermore advantageous if the spacer element is screw-fitted, adhesively bonded, or interference-fitted to the contact element. Dissimilar fastening modes can be advantageous, depending on the embodiment of the contact element. In particular in the case of a contact element having a comparatively high flexibility, such as arises in the use of a plastics material, for example, adhesive bonding can be advantageous as opposed to screw-fitting in order for a distortion of the contact element to be avoided.

It is also expedient if the spacer element is embodied to be integral to the contact element and conjointly with the contact element forms a common unit. An integral embodiment is advantageous since the number of individual components in the filling level indicator is reduced on account thereof, on account of which the production is simplified and the production costs are lowered. By way of an integral embodiment it can furthermore be prevented that distortions arise between the contact element and the spacer element, on account of which the measurement of the filling level could ultimately be negatively influenced.

It is moreover advantageous if the resistor network has a plurality of contact faces disposed so as to be mutually spaced apart, wherein an electric signal is capable of being generated by bringing the contact region of the contact element into contact with at least one contact face of the resistor network, wherein each contact face of the resistor network reflects a defined filling level in the tank. This is advantageous for being able to provide an indication pertaining to the filling level in the fuel tank, depending on the position of the magnet element. The magnet element herein, depending on the position thereof which correlates directly with the position of the float of the filling level sensor, deflects only a specific part-region of the contact element. On account thereof, an electric contact is generated between said deflected part-region of the contact element and a specific contact face of the resistor network. An indication pertaining to the filling level in the fuel tank can thus be made by assigning the respective electric resistances of the resistor network and the positions of the float, or the magnet element, respectively.

Advantageous refinements of the present invention are described in the dependent claims and in the following description of the FIGURES.

### BRIEF DESCRIPTION OF THE DRAWINGS

The invention will be discussed in detail below on the basis of an exemplary embodiment and with reference to the drawing. In the drawing:

The FIGURE is a sectional view through the housing of a filling level indicator, wherein the contact element, the spacer piece, and the carrier substrate having the resistor network applied thereon, are to be seen in particular.

### PREFERRED EMBODIMENT OF THE INVENTION

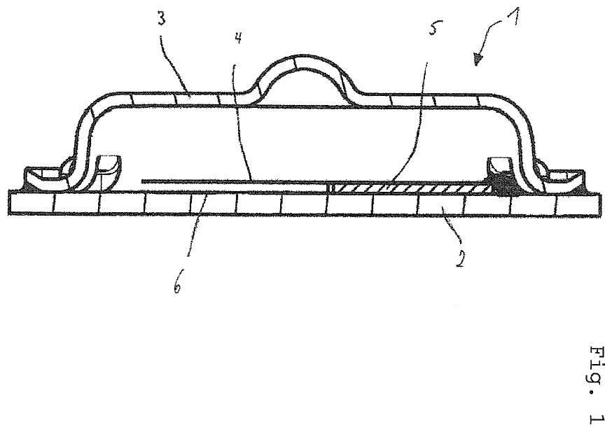

FIG. 1 shows a sectional view through a filling level indicator 1. The filling level indicator 1 has a housing 3 and a carrier substrate 2 in which the contact element 4 and the spacer element 5 are disposed. The carrier substrate 2 is preferably formed from a ceramic material. A resistor network 6 is applied to the carrier substrate 2. The resistor network 6 comprises an electrically conductive network, wherein each portion of the resistor network 6 is assigned a specific electric resistance.

The contact element 4 is spaced apart from the resistor network 6 by the spacer element 5. On account thereof, a defined spacing is generated between the contact element 4 and the resistor network 6. An electric contact can be generated between the contact element 4 and the resistor network 6 by deflecting the contact element 4 in the direction of the resistor network 6. A current circuit can be closed by this electric contact, on account of which a signal that can be processed by a downstream control unit is generated.

The spacer element 5 in the exemplary embodiment of the FIGURE is formed by a metallic material which is in particular configured so as to be resistant to the corrosive influences of the fuel. In one alternative embodiment the spacer element 5 can also be formed by a plastics material which has sufficiently resistant material properties.

A magnet element which is disposed below the carrier substrate 2, or the resistor network 6, respectively, is not illustrated in the FIGURE. The magnet element can be moved along the carrier substrate 2, on account of which a partial deflection of the contact element 4 can be caused.

The spacer element 5 is preferably adhesively bonded, welded, interference-fitted, or screw-fitted to the contact element 4 and/or the carrier substrate 2. Alternative fastening methods between the aforementioned elements are also envisageable.

The objective pursued by the filling level indicator 1 is in particular the achievement of a filling level indicator 1 that does not have to be completely sealed in relation to the fuel that surrounds the filling level indicator 1. Minor quantities which do enter the filling level indicator 1 according to the exemplary embodiment of FIG. 1 do not have any damaging influence on the spacer element 5. A filling level indicator 1 that has a particularly high resistance to the damaging corrosive influences of the fuel is thus achieved. This is in particular favorable in terms of a long durability.

The exemplary embodiment in the FIGURE is in particular not of a limiting nature, and serves for illustrating the concept of the invention. Embodiments which deviate from the exemplary embodiment of FIG. 1, in particular in terms of the dimensions, the choice of material, or the design of individual elements, are likewise envisageable and are within the scope of protection of the present invention, as long as a sufficient resistance of the spacer element 5 in relation to the fuel is achieved.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A filling level indicator for determining a filling level in a tank, comprising:
a resistor network;
a contact element disposed so as to be spaced apart from the resistor network;
a magnetic element configured to be movable relative to the resistor network and the contact element;
a contact region of the contact element that is deflectable by the magnetic element;
wherein an electrically conductive connection between the contact region and the resistor network is established by a deflection of the contact region; and
a spacer element formed from a fuel-resistant material disposed between the contact element and the resistor network and configured to generate a predefinable spacing between the contact element and the resistor network.

11. The filling level indicator as claimed in claim 10, wherein the fuel-resistant material is a corrosion resistant metallic material.

12. The filling level indicator as claimed in claim 10, wherein the contact element is formed from a plastics material.

13. The filling level indicator as claimed in claim 10, further comprising:
an electrically conductive coating on the contact element arranged on that side that faces the resistor network.

14. The filling level indicator as claimed in claim 10, wherein the spacer element is temperature-insensitive and dimensionally stable in a temperature range from −40 degrees to +125 degrees celcius.

15. The filling level indicator as claimed in claim 10, further comprising:
a ceramic carrier substrate on which the resistor network and the spacer element are disposed;
wherein the spacer element is one of screw-fitted, adhesively bonded, or interference-fitted to the ceramic carrier substrate.

16. The filling level indicator as claimed in claim 10, wherein the spacer element is one of screw-fitted, adhesively bonded, or interference-fitted to the contact element.

17. The filling level indicator as claimed in claim 10, wherein the spacer element is embodied integral to the contact element and conjointly with the contact element to form a common unit.

18. The filling level indicator as claimed in claim 10,
wherein the resistor network has a plurality of contact faces which are disposed so as to be mutually spaced apart,
wherein an electric signal is generated by bringing the contact region of the contact element into contact with at least one contact face of the resistor network, and
wherein each contact face of the resistor network reflects a defined filling level in the tank.

19. The filling level indicator as claimed in claim 10,
wherein the spacer element is configured to generate the predefinable spacing between the contact region of the contact element and the resistor network.
